(19) United States
(12) Patent Application Publication
(10) Pub. No.: US 2010/0252535 A1
(43) Pub. Date: Oct. 7, 2010

(54) Contact tip for an electrode of a resistance welder

(75) Inventors: Keith A. Spencer, Danville, KY (US); Clay Donaldson, Lancaster, KY (US); Thomas M. Fogh, Stanford, KY (US); Richard Allan Haaff, Vincennes, IN (US)

Correspondence Address: KENNETH F. PEARCE, 631 DENMARK DRIVE, DANVILLE, KY, 40422-2419, US

(73) Assignee: Ascend Enterprises, LLC

(21) Appl. No.: 12/384,489

(22) Filed: Apr. 6, 2009

(51) Int. Cl. B23K 11/30

(52) U.S. Cl. 219/119

(57) ABSTRACT

A contact tip used with the electrode of a resistance welder. The contact tip includes a bore that has an insert of blended tungsten and copper inserted therein. Prior to insertion of the insert into the bore, the bore is lined with a composition containing silver. A brazing process can be utilized to enhance attachment of the insert to the contact tip.

### BACKGROUND OF THE INVENTION

1. Field of the Invention

In the most general sense, the present invention relates to contact tips for resistance welders. The contact tip has a body that is provided with an aperture at a first end and a bore at a second end. Bodies are made of copper alloys. An insert of blended tungsten and copper is inserted into the body's bore. In preferred embodiments, the insert extends beyond the outer periphery of the body. A layer of a composition containing silver is applied to the bore prior to insertion of the insert. A brazing process can be utilized to enhance attachment of the insert to the contact tip.

2. Description of the Previous Art

1) US Published Patent Application 20050155960-Bonnet discloses a laser/arc hybrid welding process for ferritic steels. Bonnet, Paragraphs 122 and 123, reads, “It should be noted that, in TIG and plasma welding, it is not possible to use oxidizing shielding gases as otherwise the tungsten electrode would be destroyed. However, if the hybrid welding equipment allows there to be two separate gas feeds, one of laser beam assistance gas and the other for the plasma or TIG arc, the laser assistance gas may be different and therefore contain oxygen since, in such a case, this oxidizing gas is not in direct contact with the tungsten electrode.

Among other things, Bonnet does not teach or suggest the use of a contact tip with a body composed of copper, chromium, zinc and lead or a body composed of copper, cobalt, nickel and zirconium, where the contact tip has a cylindrical bore that is lined with a silver composition or a blended tungsten and copper insert for insertion into the bore.

2) U.S. Pat. No. 5,126,528-Bush, et al. enables a resistance welding electrode having an angled nose and process of fabrication thereof. Column 9, lines 33-41, reads, “The metallurgy used for electrode body 125 or electrode body 225 or electrode body 725 or the other electrodes in FIGS. 8A-13A may vary, but preferably is a conventional copper alloy. For example, such copper alloy may be copper alloyed or otherwise combined with one or more metals selected from the group consisting of chromium, zirconium, cadmium, cobalt, nickel, beryllium, tungsten, aluminum, tungsten carbide, iron, and molybdenum.”

Among other things, Bush does not teach or suggest the use of a contact tip that has a cylindrical bore that is lined with a silver composition or a blended tungsten and copper insert for insertion into the bore.

3) U.S. Pat. No. 5,015,816-Bush, et al. enables a resistance welding electrode and process. Column 8, lines 25-32, reads, “The metallurgy used for electrode body 125 or electrode body 225 or electrode body 725 may vary, but preferably is a conventional copper alloy. For example, such copper alloy may be copper alloyed or otherwise combined with one or more metals selected from the group consisting of chromium, zirconium, cadmium, cobalt, nickel, beryllium, tungsten, aluminum, tungsten carbide, iron, and molybdenum.”

Among other things, Bush does not teach or suggest the use of a contact tip that has a cylindrical bore that is lined with a silver composition or a blended tungsten and copper insert for insertion into the bore.

4) U.S. Pat. No. 2,051,284-Ball enables an weld tip. Page 2, Column 2, lines 9-12, reads, “Moreover, only the tip need be formed of pure copper, copper alloy or relatively expensive metal, whereas the body may be formed of cheaper material, if desired.”

Among other things, Smith does not teach or suggest the use of a contact tip with a body composed of copper, chromium, zinc and lead or a body composed of copper, cobalt, nickel and zirconium, where the contact tip has a cylindrical bore lined with a silver composition or a blended tungsten and copper insert for insertion into the bore.

5) U.S. Pat. No. 3,639,161-Trattner, et al. enables melt-resistant weld electrodes. Column 3, lines 1-9, reads, “The electrodes (composed of high-melting metallic materials, having melting characteristics of a melt-resistant or nonconsumable welding electrode such as tungsten, or a doped tungsten welding electrode wherein the doping material is selected from thorium, thorium dioxide, zirconium, zirconium dioxide, rhenium, rhenium dioxide and other similarly high-melting metals and metal oxides) are coated, at least on their tips, with a stable layer of high-melting metal-non-metal compound such as metal oxides, carbides, nitrides, or mixture thereof.”

Among other things, Trattner does not teach or suggest the use of a contact tip with a body composed of copper, chromium, zinc and lead or a body composed of copper, cobalt, nickel and zirconium, where the contact tip has a cylindrical bore that is lined with a silver composition or a blended tungsten and copper insert for insertion into the bore.

6) U.S. Pat. No. 4,588,870-Nadkarni, et. al. enables an resistance welding cap. Column 1, lines 55-64, reads, “The manufacture of automobiles is the largest application of resistance welding today. Until fairly recently virtually all the caps generally used in such service were of high strength, high conductivity copper alloys such as copper alloyed with a little chromium, zirconium, cadmium, cobalt, nickel, beryllium, tungsten, molybdenum, or a combination of these alloying agents. Representative alloys of this sort can contain about 0.1% to about 0.2% zirconium and about 0.6% to about 1% chromium. (For brevity, such metals and alloys may be referred to from time to time in this specification simply as “copper alloys”, because a copper-base alloy has been for so long the mainstay cap material for resistance welding operations in automobile production).”

Among other things, Nadkarni does not teach or suggest the use of a contact tip that has a cylindrical bore that is lined with a silver composition or a blended tungsten and copper insert for insertion into the bore.

7) U.S. Pat. No. 5,714,735-Offer enables a method and apparatus for joining components with multiple filler materials. FIG. 2 teaches tungsten electrode (8). Column 10, line 68—Column 11, line 3, read, “Electrode holder 30 is preferably made of a conductive, oxidation-resistant material such as copper alloy (e.g., beryllium-copper alloy), optionally

Based on the current record, among other things, Offer does not teach or suggest use of a contact tip with a body composed of copper, chromium, zinc and lead or a body composed of copper, cobalt, nickel and zirconium, where the contact tip has a cylindrical bore that is lined with a silver composition or a blended tungsten and copper insert for insertion into the bore.

8) U.S. Pat. No. 6,225,591-Nippert, et al. enables a resistance welding electrode and process for the electrode. Column 4, lines 23-25, read, “Preferably, the insert is formed from an internally oxidized copper-aluminum alloy or dispersion strengthened copper. The main body may be formed from a high conductivity copper or a silver bearing copper.”

Based on the current record, among other things, Nippert does not teach or suggest use of a contact tip with a body composed of copper, chromium, zinc and lead or a body composed of copper, cobalt, nickel and zirconium, where the contact tip has a cylindrical bore that is lined with a silver composition or a blended tungsten and copper insert for insertion into the bore.

9) US Published Patent Application 20060261046-Scotchmer discloses a welding electrode and method. Paragraph 41 reads, “Referring to FIG. 3, tip region 60 may have a coating 70 formed thereon, as discussed below. It may be that body 30, may be made from a substantially pure copper, or a copper based alloy, having relatively high thermal conductivity (perhaps greater than 200 W/m K). Some alloys may be predominantly ternary alloys composed of Copper, Chromium and Zirconium (CuCrZr). Other alloys may be predominantly binary alloys, such as Copper and Zirconium (CuZr) or Copper and Chromium (CuCr). Copper Tungsten (CuW) and Copper Alumina (Cu—Al₂O₃) alloys may also possible alternate coating materials. One copper alloy with silver is suggested in U.S. Pat. No. 4,734,254 of Nippert, issued Mar. 29, 1988. Another alloy may be a dispersion strengthened alloy, as discussed in U.S. Pat. No. 4,423,617 of Nippert, issued Jan. 3, 1984. The dispersion strengthened alloy may be included in a portion of electrode 20 such as, for example only that portion forming the tip thereof.”

Based on the current record, among other things, Scotchmer does not teach or suggest use of a contact tip with a body composed of copper, chromium, zinc and lead or a body composed of copper, cobalt, nickel and zirconium, where the contact tip has a cylindrical bore that is lined with a silver composition or a blended tungsten and copper insert for insertion into the bore.

10) US Published Patent Application 20060151453-Gordon discloses a consumable electrode arc welding. Paragraph 21 reads, “According to the present invention, there is provided a contact tip suitable for electric arc welding using a consumable electrode, wherein the contact tip has a body which defines a bore through which the electrode is able to pass, to enable electric current from a welding power supply to be transferred from the body to the electrode. Within a part of the length of the bore between an inlet end and an outlet end thereof, there is at least one region (hereinafter referred to as the primary contact region) at which the body is adapted to enable primary electrical contact with the electrode. Along the remainder part of the length of the bore, the body is adapted such that, in the event of any secondary contact between the body and the electrode along the remainder of the bore, the secondary contact does not substantially short circuit the primary electrical contact in the primary contact region of the bore.”

Paragraphs 138 and 139 read, “A practical alternative to increasing excessively the contact entry length is to use a different combination of materials at the entrance of the tip. FIG. 9 shows one example successfully trialled for use at high wire feed speeds and a wire consumable of diameter 1.2 mm. In FIG. 9 there is shown a contact tip 50 e in which components corresponding to those of tip 50 of FIG. 4 have the same reference numeral plus “e”. The tip 50 e has a body which defines sections 54 e and 60 e and which is mostly of copper. However, section 54 e includes an insert 74 within the copper body. The insert 74 is of annular form and of sintered tungsten. The insert 74 defines the taper 59 e and defines a 3 mm long inlet part of bore length 61 e of bore 52 e. The outside diameter of the tungsten insert 74 is approximately 0.05 mm larger than the recess in the copper part of section 54 e and the insert 74 is pressed into the copper body during assembly of the tip. The tungsten insert provides the first of two current delivery components with tungsten being chosen for its resistance to sliding wear by the wire consumable. Immediately following the tungsten insert 74, there is an 8 mm part bore length 61 e defined by copper. Relative to tungsten, the copper has low resistance to sliding wear and, in this arrangement, the copper has in effect replaced the graphite insert shown in tips of the type shown in FIG. 6. The section 64 e of the tip is an 18 mm long insert of machineable ceramic. For wire of diameter 1.2 mm the diameter of the part of bore length 61 e in the tungsten insert 74 is approximately 1.3 mm, the diameter of the part of the bore length 61 e of copper is approximately 1.25 mm and the diameter of the bore length 62 e in the ceramic insert is of section 64 e approximately 2.0 mm. As wire enters the tip it slides over the tungsten insert 74 and beds itself into the copper and is subsequently guided out of the tip through the ceramic section 64 e. The step change in diameter of the conducting part of the bore is small but significant. The step is large enough to establish a well defined contact area in the copper at or beyond the step. The precise location depends on the clearance between wire and bore, the wire stiffness and curvature. The back-up current delivery area is the tungsten insert in the region adjacent to the step. Both current delivery areas operate at essentially the same potential and an open circuit condition is unlikely. The preheat length is well defined and the wire melting rate uniform. Any obstruction to the smooth passage of wire is small and high wire feed speeds are therefore attainable. The lifetime of this type of tip is controlled by the wear rate of the tungsten. For non-pulsed GMAW and a wire feed speed of approximately 15 m/minute, the current required to maintain that melting rate is approximately 290 A for an applied voltage of 34V. For a conventional copper tip at the same wire feed speed the current required is approximately 400 A. The lifetime of the tip even at this high wire feed speed is approximately 2 hours. Tungsten is difficult to machine and is relatively expensive, and insert 74 therefore would preferably be sintered to as close to its final dimensions as possible. Other viable alternatives are hardenable carbon steels, silver steel, white irons and nickel and cobalt based hardfacing alloys. One tool steel, namely silver steel, has been found to be both effective and convenient to use. This is silver steel which is a 1% carbon tool steel supplied centreless ground to close tolerances. It is machineable and may be substantially hardened by heat treatment after machining. It has been successfully used as an alternative to tungsten both in its original as supplied condition and in its heat treated condition. One other option to a tungsten copper combination as described in FIG. 9 is to have an insert of silver steel in a body of mild steel. This would provide a good match between the coefficients of thermal expansion between the body and the insert.”

Gordon teaches a cylindrical bore extending through the weld tip. Gordon does not teach or suggest use of a contact tip with a body composed of copper, chromium, zinc and lead or a body composed of copper, cobalt, nickel and zirconium, where the contact tip has a cylindrical bore is lined with a silver composition or a blended tungsten and copper insert for insertion into the bore.

### SUMMARY OF THE INVENTION

The present contact tip is attached to a resistance welder. Among other things, the current contact tip is particularly useful when attached to the electrode of a resistance welder. Within the scope of the present invention, contact tips have inserts composed of blends of tungsten and copper. Prior to the invention of the current contact tips, it is believed that previous contact tips did not line the bore of the contact tip with a layer of a composition containing silver. In practice, after the insert is inserted into the bore of the body of the contact tip, the insert abuts the silver layer applied to the bore.

An aspect the present invention is to provide a contact tip for an electrode of a resistance welder where the contact tip provides about four times the service life of prior art weld tips.

It is another aspect of the present invention is to provide inserts for a contact tip for an electrode of a resistance welder where the insert is replaceable.

Still another aspect of the present invention is to provide inserts for a contact tip for an electrode of a resistance welder where inserts rather than the body of the contact tip are replaced.

Yet another aspect of the present invention is to provide inserts for a contact tip for an electrode of a resistance welder where inserts are primarily composed of blends of tungsten and copper.

Still another aspect of the present invention is to apply a layer of a composition containing silver to the bore of the contact tip that receives the insert, where the elementary concentrations of the composition containing silver are varied according to predetermined engineering parameters.

It is another aspect of the present invention to provide generally bullet shaped contact tip as well as contact tips manufactured to other dimensions.

Yet another aspect of the present invention is to provide a contact tip for an electrode of a resistance welder where the contact tip is lesser cost to the consumer than previous art resistance weld tips.

Still another aspect of the present invention is provide a contact tip for an electrode of a resistance welder that increases the quality of the weld over previous resistance weld tips.

It is another aspect of the present invention to provide a contact tip for an electrode of a resistance welder that requires less electrical power consumption that previous resistance weld tips.

Yet another aspect of the present invention is to provide an environmentally friendly contact tip where, in response to the wear and tear of use, the insert rather than the body of the contact tip can be replaced.

Still another aspect of the present invention is to provide a contact tip for an electrode of a resistance welder that decreases sticking of the contact tip to zinc-plated metal.

An embodiment of the present invention can be described as a resistance welder comprising an electrode and a contact tip affixed to an end of the electrode, wherein the contact tip comprises: a) a generally bullet shaped body sized to fit securely about the end of the electrode; b) a layer of a composition containing silver lining a generally cylindrically shaped bore; and c) a generally cylindrical insert comprising a combination of tungsten and copper, wherein the insert is inserted in the generally cylindrically shaped bore such than an edge of the insert extends beyond the outer periphery of a generally convex end of the body.

Another embodiment of the present invention can be described as a replaceable contact tip connectable with an end of an electrode of a resistance welder comprising: a) a convex contact end; b) a connectable end; c) a recess extending from proximate the contact end toward the connectable end; d) a bore extending into the convex contact end; e) a layer of a composition containing silver lining the bore; and f) an insert abutting the layer of the silver composition, wherein the insert comprises a combination of tungsten and copper.

Another embodiment of the present invention can be described as a replaceable contact tip connectable with an end of an electrode of a resistance welder, comprising: a) copper, chromium and zinc or lead or copper, cobalt and nickel or zirconium; b) a recess extending from proximate a work piece contact end to a connectable end; c) a bore, lined with a layer of a composition containing silver; and d) an insert abutting the layer of the composition containing silver, wherein the insert comprises a combination of tungsten and copper.

Another embodiment of the present invention can be described as a contact tip for an end of an electrode of a resistance welder, comprising: a) a connectable end; b) a work piece contact end comprising: a bore lined with a composition containing silver; and c) an insert comprising a combination of tungsten and copper abutting the layer of said composition containing silver.

It is the novel and unique interaction of these simple elements which creates the methods, within the ambit of the present invention. Pursuant to Title 35 of the United States Code, descriptions of preferred embodiments follow. However, it is to be understood that the best mode descriptions do not limit the scope of the present invention.

### BRIEF DESCRIPTION OF THE DRAWINGS

FIG. 1 is an exploded isometric pictorial of an embodiment of a contact tip.

FIG. 2 is an isometric pictorial of another embodiment of a contact tip.

FIG. 3 is an exploded half section of a contact tip.

### DESCRIPTION OF THE PREFERRED EMBODIMENTS

Although the disclosure hereof is detailed to enable those skilled in the art to practice the invention, the embodiments published herein merely exemplify the present invention.

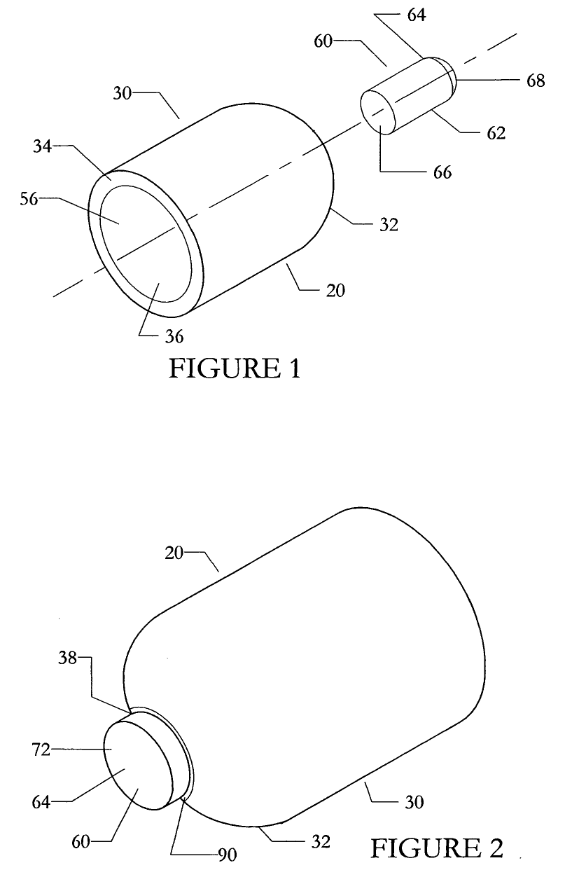

Although a resistance welder is not shown in the drawings, embodiments of the current contact tip for an electrode of a resistance welder are portrayed in FIGS. 1-3. For ease of understanding, descriptions of the preferred embodiments disclosed herein may be referenced in one or more of FIGS. 1-3.

FIG. 1 is an exploded isometric pictorial an embodiment of contact tip (20) including body (30) and insert (60).

FIG. 2 is an isometric pictorial of contact tip (20) incorporating insert (60) having a first end tip (64) extending from body (30).

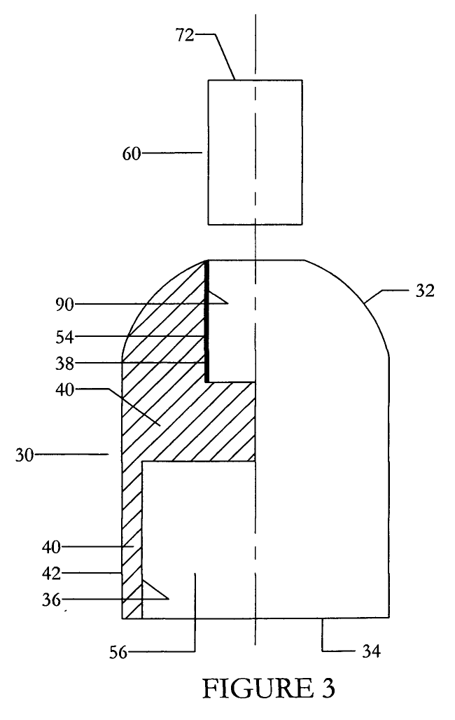

FIG. 3 is an exploded half section of contact tip (20) showing body (30), generally solid region (40) between periphery (42) and aperture (36), bore (38) and layer (90) of a composition containing silver.

Although the contact tips (20) enabled in FIGS. 1-3 show generally bullet shaped configurations, contact tips having dimensions other that bullet-like are within the scope of the present invention. In other words, the shape of the electrodes to be fitted with contact tips, within the ambit of the present invention, controls the dimensions of the contact tips.

As previously indicated, contact tip (20) includes body (30) and insert (60). Body (30) can be provided with rounded end (32), electrode connectable end (34), aperture (36) and bore (38). Aperture (36) is sized to fit about the tip of an electrode of a resistance welder. Generally cylindrically shaped insert (60) is provided with a generally cylindrical body (62), a first end tip (64) and a second end tip (66). As shown in FIG. 1, first end tip (64) has a rounded or convex dimension (68). Depending on engineering parameters, preferred embodiments of first end tip (64) can be of either a generally flat or a convex dimension.

With a view toward FIG. 2, contact tip (20) includes body (30), insert (60) and layer (90) of a composition containing silver. Insert (60) has a first end tip (64) with a generally flat dimension (72). Layer (90) of a composition containing silver is brazed to bond layer (90) to bore (38).

As can be seen in FIG. 3, body (30) has a generally solid region (40) between periphery (42) and aperture (36) and bore (38). Generally solid region (40) surrounding bore (38) (work piece contact end) is of greater mass than generally solid region (40) surrounding aperture (36) (electrode connectable end). The combination of aperture (36) and generally solid region (40) create recess (56) that can be fitted for an electrode of a resistance welder. As shown, bore (38) does not extend through generally solid region (40) to recess (56), but in select embodiments, bore (38) can extend through generally solid region (40) to recess (56). Affixed to exposed surface (54) of bore (38) is layer (90) of a composition containing silver. Applicants' have determined that preferred thicknesses of layer (90) of contact tip (20) are from about 0.001 micrometers to about 2 millimeters.

Within the scope of embodiments of the present invention, Applicants' experiments have revealed that compositions of the bodies can include blends of:
a) from about 96.3% w/w copper to about 99.8% w/w copper;
b) from about 0.2% w/w cobalt to about 2.7% w/w cobalt;
c) from about 0% w/w nickel to about 1.25% w/w nickel; and
d) from about 0% w/w zirconium to about 1.5% w/w zirconium.

Within the ambit of embodiments of the current invention, through experimentation, Applicants have determined that compositions of the bodies can include blends of:
a) from about 96.6% w/w copper to about 99.6% w/w copper;
b) from about 0.12% w/w chromium to about 1.20% w/w chromium;
c) from about 0% w/w zinc to about 0.7% w/w zinc; and
d) from about 0% w/w lead to about 0.05% w/w lead.

Within the scope of embodiments of the current invention, through experimentation, Applicants have concluded that compositions of the inserts can include blends of:
a) from about 10% w/w copper to about 75% w/w copper; and
b) from about 25% w/w tungsten to about 90% w/w tungsten.

Within the scope of embodiments of the current invention, through laboratory testing, Applicants have concluded that compositions containing silver used to practice the present invention can include blends of:
a) from about 1% w/w silver to about 92% w/w silver;
b) from about 20% w/w copper to about 97% w/w copper;
c) from about 0% w/w zinc to about 43% w/w zinc;
d) from about 0% w/w nickel to about 10% w/w nickel;
e) from about 0% w/w tin to about 10% w/w tin; and
f) from about 0% w/w phosphorus to about 10 w/w phosphorous.

Applicants have discovered that embodiments of the current contact tips containing compositions including silver are advantageous over previous weld rips for resistance welders. By way of illustration the disclosed combinations of silver, copper and tungsten are better electrical conductors than the previous weld tips. Further, the brazing of the composition containing silver, the contact tip body and the insert improves affixation of the insert to the contact tip body. The brazing process of the composition containing silver, the contact tip body and the insert creates a contact tip that causes a reduction of electrical power consumption required by the electrode in generating the weld.

Having disclosed the invention as required by Title 35 of the United States Code, Applicants now pray respectfully that Letters Patent be granted for their invention in accordance with the scope of the claims appended hereto.

1-18. (canceled)

19. A resistance welder comprising an electrode and a contact tip affixed to an end of said electrode, wherein said contact tip comprises:
a) a generally bullet shaped body sized to fit securely about said end of said electrode, said bullet shaped body comprising:
i) an outer periphery and a generally convex end;
ii) a recess extending from about said generally convex end toward an open end of said generally bullet shaped body;
iii) a generally cylindrically shaped bore distinct from and concentric with said recess and extending from said outer periphery of said generally convex end toward said recess; and
iv) a solid region between said outer periphery, said bore and said recess; and
v) blends of:
copper, chromium, zinc and lead; or
copper, cobalt, nickel and zirconium;
b) from about 0.001 micrometers to about 2 millimeters of a composition containing silver brazed onto said generally cylindrically shaped bore, wherein said composition containing silver comprises:
i) from about 1% w/w silver to about 92% w/w silver;
ii) from about 20% w/w copper to about 97% w/w copper;
iii) up to about 43% w/w zinc; and one or more of the following:
A) up to about 10% w/w nickel;
B) up to about 10% w/w tin;
C) up to about 10% w/w phosphorous; and
c) a generally cylindrical insert comprising:
i) a generally convex outward edge for engaging a work piece, said generally convex outward edge extending beyond said outer periphery of said generally convex end of said generally bullet shaped body; and
ii) a combination of tungsten and copper; said combination comprising:
A) from about 10% w/w copper to about 75% w/w copper; and
B) from about 25% w/w tungsten to about 90% w/w tungsten.

20. The invention of claim 19, wherein said generally bullet shaped body comprises blends of:
a) from about 96.6% w/w copper to about 99.6% w/w copper;
b) from about 0.12% w/w chromium to about 1.20% w/w chromium;
c) up to about 0.7% w/w zinc; and
d) up to about 0.05% w/w lead.

21. The invention of claim 19, wherein said generally bullet shaped body comprises blends of:
a) from about 96.3% w/w copper to about 99.8% w/w copper;
b) from about 0.2% w/w cobalt to about 2.7% w/w cobalt;
c) up to about 1.25% w/w nickel; and
d) up to about 1.5% w/w zirconium.

22. A replaceable contact tip connectable with an end of an electrode of a resistance welder, comprising:
a) a convex contact end;
b) a connectable end, opposite said contact end, for fitting with said end of said electrode;
c) a recess extending from proximate said convex contact end to said connectable end;
d) a bore, concentric with and distinct from said recess, extending inward from said convex contact end;
e) a layer of a composition containing silver lining said bore; said layer comprising:
i) from about 1% w/w silver to about 92% w/w silver;
ii) from about 20% w/w copper to about 97% w/w copper; and
two or more of the following:
A) up to about 43% w/w zinc;
B) up to about 10% w/w nickel;
C) up to about 10% w/w tin;
D) up to about 10% w/w phosphorous; and
f) a generally cylindrical insert comprising a combination of tungsten and copper, wherein said combination comprises more tungsten than copper; and wherein said generally cylindrical insert abuts said layer and extends to approximately said recess and outwardly beyond said bore.

23. The invention of claim 22, wherein said convex contact end and said connectable end comprise:
a) copper, chromium and zinc or lead; or
b) copper, cobalt and nickel or zirconium;

24. The invention of claim 23, wherein said convex contact end and said connectable end comprise:
a) from about 96.6% w/w copper to about 99.6% w/w copper;
b) from about 0.12% w/w chromium to about 1.20% w/w chromium;
c) up to about 0.7% w/w zinc; and
d) up to about 0.05% w/w lead.

25. The invention of claim 23, wherein said convex contact end and said connectable end comprise:
a) from about 96.3% w/w copper to about 99.8% w/w copper;
b) from about 0.2% w/w cobalt to about 2.7% w/w cobalt;
c) up to about 1.25% w/w nickel; and
d) up to about 1.5% w/w zirconium.

26. A replaceable contact tip connectable with an end of an electrode of a resistance welder, comprising:
a) a generally bullet shaped body comprising: copper, chromium and zinc or lead or copper, cobalt and nickel or zirconium;
b) a bore brazed with a layer of a composition containing silver; said composition comprising:
i) from about 1% w/w silver to about 92% w/w silver;
ii) from about 20% w/w copper to about 97% w/w copper; and two or more of the following:
A) up to about 43% w/w zinc;
B) up to about 10% w/w nickel;
C) up to about 10% w/w tin; or
D) up to about 10% w/w phosphorous;
c) a recess extending from proximate a connectable end toward said bore; and
d) an insert for engaging a work piece; said insert abutting said layer and extending beyond said bore, wherein said insert comprises a combination of tungsten and copper.

27. The invention of claim 26, wherein said insert further comprises at least one convex end.

28. The invention of claim 27, wherein said combination of tungsten and copper comprises:
a) from about 10% w/w copper to about 75% w/w copper; and
b) from. about 25% w/w tungsten to about 90% w/w tungsten.

29. The invention of claim 28, wherein said generally bullet shaped body comprises:
a) from about 96.6% w/w copper to about 99.6% w/w copper;
b) from about 0.12% w/w chromium to about 1.20% w/w chromium;
c) up to about 0.7% w/w zinc; and
d) up to about 0.05% w/w lead.

30. The invention of claim 28, wherein said generally bullet shaped body comprises:
a) from about 96.3% w/w copper to about 99.8% w/w copper;
b) from about 0.2% w/w cobalt to about 2.7% w/w cobalt;
c) up to about 1.25% w/w nickel; and
d) up to about 1.5% w/w zirconium.

31. A contact tip for an end of an electrode of a resistance welder, comprising:
a) a body comprising:
i) a generally rounded end;
ii) a connectable end opposite said generally rounded end for fitting with said end of said electrode;
iii) a bore lined with a composition containing silver;
iv) a recess extending from said connectable end toward said bore;
v) copper, chromium and zinc or lead or copper, cobalt and nickel or zirconium; and
b) an insert comprising a combination of tungsten and copper abutting said composition containing silver.

32. The invention of claim 31, wherein said insert extends beyond said generally rounded end.

33. The invention of claim 32, wherein said insert comprises:
a) from about 10% w/w copper to about 45% w/w copper; and
b) from about 55% w/w tungsten to about 90% w/w tungsten.

34. The invention of claim 33, wherein said silver composition comprises:
a) from about 1% w/w silver to about 92% w/w silver;
b) from about 20% w/w copper to about 97% w/w copper;
c) from about 0% w/w zinc to about 43% w/w zinc;
d) from about 0% w/w nickel to about 10% w/w nickel;
e) from about 0% w/w tin to about 10% w/w tin; and
f) from about 0% w/w phosphorus to about 10% w/w phosphorous.

35. The invention of claim 34, wherein said insert further comprises at least one rounded end.
